(19) United States
(12) Patent Application Publication
(10) Pub. No.: US 2006/0182437 A1
(43) Pub. Date: Aug. 17, 2006

(54) Method and apparatus for previewing a panoramic image on a digital camera

(76) Inventors: Karen E. Williams, Fort Collins, CO (US); Christopher Webb, Wellington, CO (US); Angelica A. Quintana, Fort Collins, CO (US)

Correspondence Address: HEWLETT PACKARD COMPANY, P O BOX 272400, 3404 E. HARMONY ROAD, INTELLECTUAL PROPERTY ADMINISTRATION, FORT COLLINS, CO, 80527-2400, US

(21) Appl. No.: 11/055,885

(22) Filed: Feb. 11, 2005

(51) Int. Cl. H04N 5/225

(52) U.S. Cl. 396/429; 348/218.1

(57) ABSTRACT

A camera and related methodology in which a stitched panoramic image may be generated from a series of individual image frames onboard the camera and displayed on the camera display in a “real-time” environment. This allows the user to preview the completed panorama on the camera without the need to first upload the image frames onto a support computer. In this manner, the user is able to identify potential problems with the panorama and, if necessary, reacquire the individual image frames. In order to reduce the amount of onboard processor power and/or memory required, stitching may be performed on relatively lower resolution image frame files within the camera. When the preview indicates that image data for the panorama has been successfully acquired, then the full resolution image data may be uploaded to a support computer for processing.

### BACKGROUND

Image mosaicing involves stitching together multiple separate sets of image information to create a composite still image. In particular, image mosaicing involves stitching together frames of digital image information that are captured by digital still cameras or digital video cameras. Image mosaicing is often utilized to generate a single panoramic image from a series of individual images.

The process of generating a high-quality image mosaic requires large digital storage and processing capacity. In order to provide the storage and processing capacity needed to create a high-quality image mosaic, a still or video digital camera can be connected to a support computer equipped with an image mosaicing application. Image information captured by the digital camera is uploaded directly from the digital camera to the support computer and stitched together by the mosaicing application into an image mosaic. The image mosaic generated by the support computer can be viewed through the support computer, printed, edited, and/or permanently stored. A stand-alone digital camera could be used to capture a sequence of images and to generate a high-quality image mosaic, however, additional processing power and storage capacity would be required to generate a high-quality image mosaic.

### BRIEF DESCRIPTION OF THE DRAWINGS

FIG. 1 is a front perspective view of a camera.

FIG. 2 is a rear elevational view of the camera of FIG. 1

FIG. 3 is a schematic illustration showing various components of the camera of FIG. 1 in conjunction with a support computer.

FIG. 4 is schematic illustration of a series of image frames acquired by the camera of FIG. 1.

FIG. 5 is a schematic illustration of a stitched panoramic image formed from the image frames of FIG. 4.

### DETAILED DESCRIPTION

In general terms, a camera is disclosed herein, along with related methodology allowing a stitched panoramic image to be generated from a series of individual image frames onboard the camera and displayed on the camera display in a “real-time” environment. This allows a user to preview the completed panorama on the camera without the need to first upload the image frames onto a support computer. In this manner, the user is able to identify potential problems with the panorama and, if necessary, reacquire the individual image frames. In order to reduce the amount of onboard processor power and/or memory required, stitching may be performed on relatively lower resolution image frame files within the camera. When the preview indicates that image data for the panorama has been successfully acquired, then the full resolution image data may be uploaded to a support computer for processing.

For purposes of the description presented herein, the term “stitched image” is synonymous with the terms “panoramic image”, “panorama” and “mosaic”. The term “stitching” is synonymous with the term “mosaicing”.

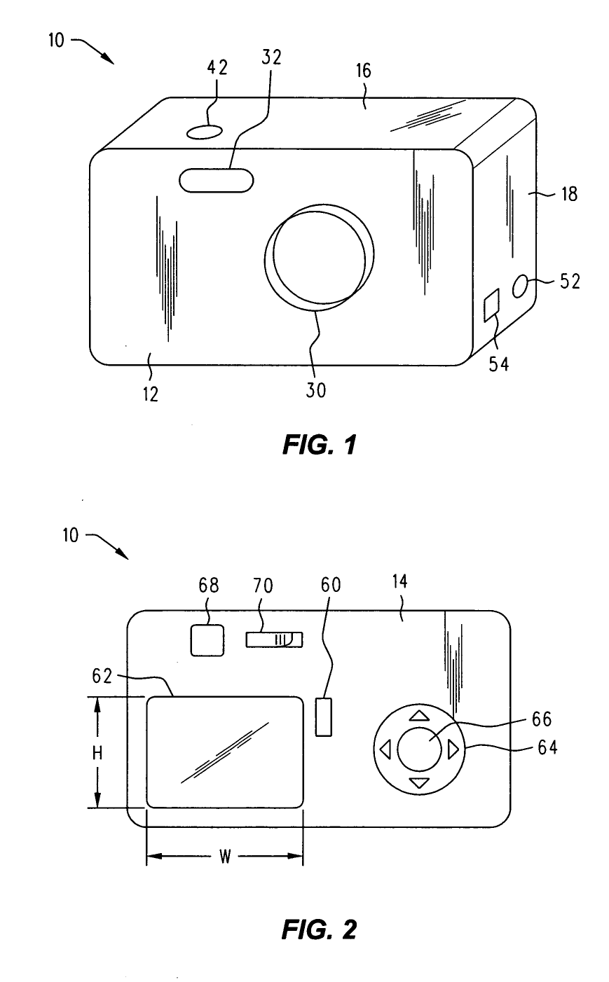

FIGS. 1 and 2 illustrate the exterior of an exemplary camera 10. Camera 10 may, for example, be a digital camera in which an image is focused onto an image sensor. In general terms, the camera 10 may include a front face 12 (FIG. 1), an oppositely disposed rear face 14 (FIG. 2), a top face 16 (FIG. 1), and a left side face 18. Top face 16 and left side face 18 generally extend between and connect the front face 12 and rear face 14. A bottom face and a right side face (not shown) are oppositely disposed relative to the top face 16 and left side face 18, respectively, and also extend between the front face 12 and rear face 14.

With reference to FIG. 1, front face 12 may, for example, include a lens assembly 30 and a flash unit 32. Top face 16 may, for example, include a shutter button 42. Left side face 18 may, for example, include a power port 52 for supplying the camera with externally-supplied electrical power, if desired. Left side face 18 may also include a data port 54 which may, for example, be a conventional USB connector port. With reference to FIG. 2, rear face 14 may include a display 62 which may, for example, be a conventional LCD-type display. Display 62 may have a width “W” and a height “H”, as indicated in FIG. 2. Rear face 14 may further include a ring-like scroll button 64 which may, for example, be capable of being actuated in one of four different directions, in a conventional manner, and a centrally located user selection button 66 which may, for example, be labeled “Menu/OK”. Scroll button 64 and selection button 66 may be operated by a user, for example, to navigate among and select various menu items displayable on the display 62 in a conventional manner. Various other features, such as a viewfinder 68, power switch 70 and playback button 60 may also be located on the rear face 14.

It is noted that the features discussed above are listed only for exemplary purposes. In practice, the camera could include additional and/or different features depending on the desired functionality of the camera, as will readily be appreciated by one skilled in the art.

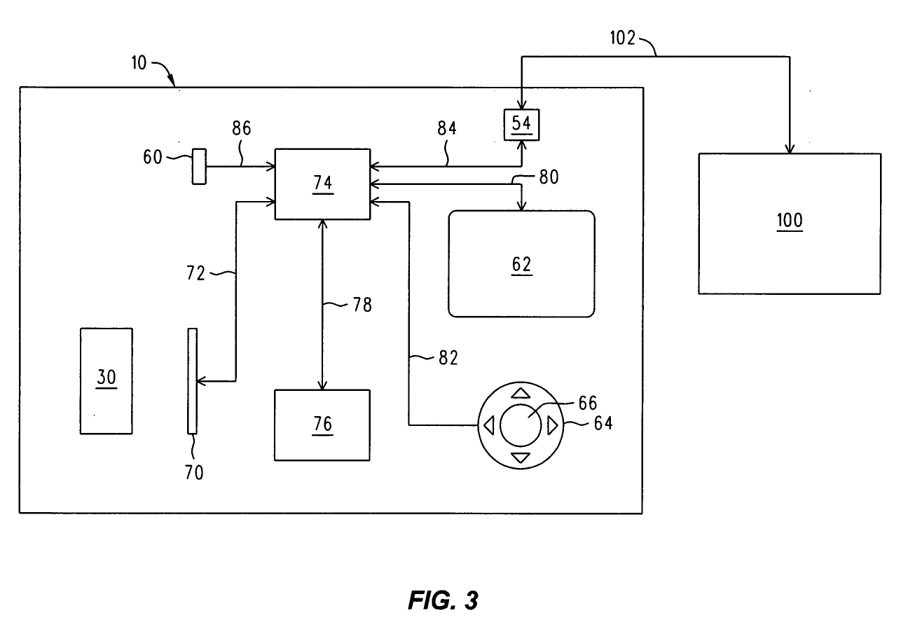

FIG. 3 schematically illustrates selected features of the camera 10. With reference to FIG. 3, the lens 30 may serve to focus an image of an object onto an image sensor 70. Image sensor 70 may, for example, be a conventional photoelectric imaging device such as a two-dimensional CCD array. A data link 72 may transfer data from the image sensor 70 to a processor 74. Processor 74 may be connected to a memory module 76 via a data link 78. The display 62 may receive data from the processor via a data link 80. A data link 82 may connect the processor 74 to the scroll button 64/selection button 66 combination. A data link 84 may extend between the processor 74 and the data port 54. A data link 86 may connect the processor 74 to the playback button 60. The camera 10 may be selectively connected to a support computer 100 via a data link 102. Support computer 100 may, for example, be a conventional personal computer. Data link 102 may, for example, take the form of a conventional USB cable extending between the is camera data port 54 and a corresponding USB port on the computer 100. Alternatively, data communication between the camera 10 and the support computer 100 may be established in any conventional manner, e.g., using another type of hardwire cabling or a wireless link based on infrared or radio frequency technology.

The camera 10 may include the ability to acquire panoramic image data in the form of a plurality of overlapping individual images. The individual image data may then be uploaded to the support computer 100, FIG. 3. Image mosaicing techniques may then be used within the support computer 100 to generate a single panoramic image, or mosaic, by combining the series of individual images. As previously discussed, image mosaicing involves stitching together multiple separate sets of image information to create a composite still image.

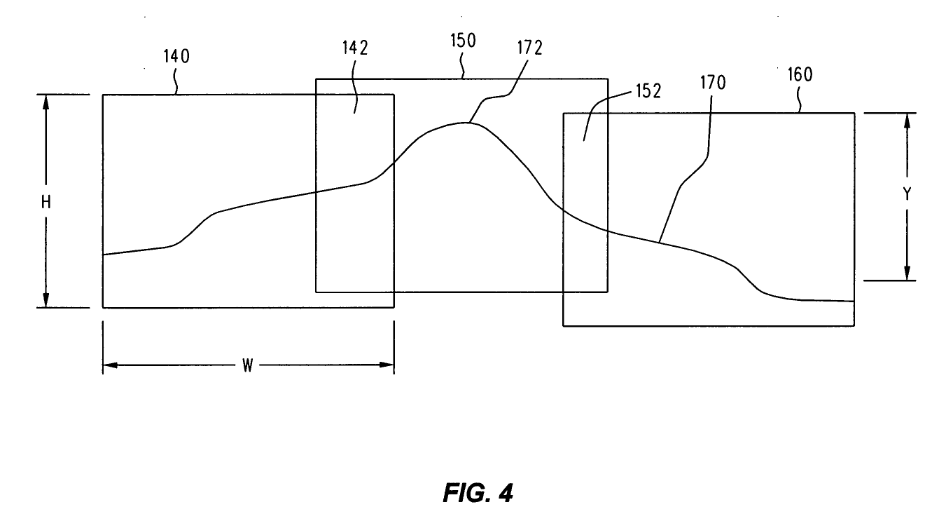

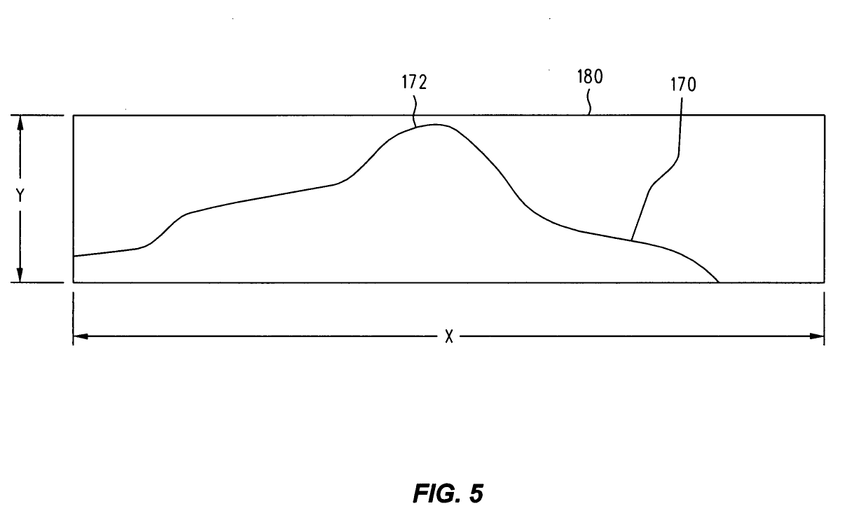

FIG. 4 schematically illustrates an exemplary sequence of image frames that may be captured by the camera 10. The sequence of image frames encompasses a view of a horizon line 170 that includes a mountain peak 172. As shown in FIG. 4 there are three individual image frames 140, 150, 160 in the sequence that are captured by panning the camera across the horizon. As can be appreciated, image frame 140 overlaps with image frame 150 in an overlap area 142. In a similar manner, image frame 150 overlaps with image frame 160 in an overlap area 152. In a manner that is well known in the art, stitching or mosaicing software looks for common data in the overlap regions 142, 152 in order to align the individual image frames 140, 150,160 and create a single composite panoramic image. FIG. 5 illustrates the single panoramic image 180 of the horizon line 170 formed from the three individual image frames 140,150, 160 by the stitching or mosaicing software. It is noted that three individual images are discussed in the above description for exemplary purposes only. In practice, a panorama could be formed from virtually any number of individual images.

With reference again to FIG. 3, after being disconnected from the support computer 100, the camera 10 may be moved to a remote location (if desired) for the purpose of acquiring panoramic image data (e.g., the images 140, 150, 160, FIG. 4). After the panoramic image data has been acquired, the camera 10 may then be reconnected to the support computer 100 and the panoramic image data uploaded to the support computer 100 where the image data may be stitched together by the mosaicing application into an image mosaic (e.g., the panoramic image mosaic 180, FIG. 5). There are several stitching/mosaicing applications well known to those skilled in the art and any of these may be used on the support computer 100 in order to form the image mosaic.

Since the process of generating a high-quality image mosaic requires large digital storage and processing capacity, this process is typically performed on a support computer (e.g., the support computer 100, FIG. 3) equipped with an image mosaicing application and not on the camera itself. Typically, image information captured by the digital camera is transferred directly from the digital camera to the support computer 100 (e.g., via the data link 102, FIG. 3) and stitched together by the mosaicing application into an image mosaic. The image mosaic generated by the support computer can be viewed through the support computer, printed, edited, and/or permanently stored. For this purpose, the camera 10 may be connected to a support computer.

As can be appreciated, it is typically necessary to wait until the camera 10 is connected to the support computer 100 and the final composite mosaic view generated by the support computer 100 before any problems with the image capture become apparent. Examples of such problems include failure to capture all of the desired image data, failure to obtain adequate overlap between images and failure to obtain vertical alignment between the images. If a problem is not discovered until after the camera 10 is reconnected to the support computer 100, then it will generally be necessary to return to the scene where the images were obtained and to reacquire the images. Accordingly, it would be desirable, during the capture of image information that is to be utilized to create an image mosaic to view at least an approximate image mosaic in real-time (e.g., on the display 62 of the camera 10) in order to determine if the target scene has been properly captured. However, real-time image mosaic building is an expensive operation, requiring a relatively high level of onboard memory and processing power.

The camera 10 disclosed herein, however, addresses this problem by providing the ability to preview the stitched composite image on the camera itself. In order to reduce the memory and processing power required, the stitching operation is performed on a lower resolution image stored within the camera. The stitching operation may, for example, be performed on a lower resolution image sometimes referred to in the industry as a “screennail” image, as will now be described in further detail. The stitching process itself may be identical to any known stitching algorithm conventionally used on a personal computer or other support computer.

For each image acquired by the camera 10, a file may be created and stored within the camera memory 76. In addition to the raw image data for each image (which may or may not be compressed), the image file may also contain other information such as a header identifying and the image represented by the image data. Further, a “screennail” image may be stored within the file. The screennail image is a reduced resolution version of the image and may optionally be compressed. The screennail image may be display-sized such that it fills the visible area of the display 62 when displayed. Accordingly, the screennail image is much smaller than the raw image data discussed above. A typical raw image may, for example, be about 2592 by 1936 pixels whereas a typical screennail image may, for example, be about 320 by 240 pixels (this exemplary screennail resolution is sometimes referred to as “QVGA” resolution). The screennail image data may be generated from the raw image data at the time that the image file is created in a conventional manner. The generation and use of screennail images and image files is well known in conjunction with digital cameras and is discussed, for example, in U.S. Pat. No. 5,933,137 of Anderson, which is hereby incorporated by reference for all that is disclosed therein.

As discussed above, performing the stitching operation onboard the camera 10 allows a user to review a panorama immediately after capture to review for potential problems. If problems are detected, then the images making up the panorama may immediately be reacquired by the camera and reviewed again. Performing the stitching operation on the screennail image data (rather than the much larger raw image data) allows the stitching to be performed onboard the camera without the need for prohibitively costly higher onboard processor capability and/or memory capacity. If the stitched panorama previewed on the camera indicates no problems with the acquired panorama images, then the images may be saved in the camera memory for later uploading to a support computer. After uploading the data to the support computer, stitching may be carried out on the full-size image data in a conventional manner.

To perform an onboard preview of a panorama, a user of the camera 10 first acquires the individual panorama image frames (e.g., the image frames 140, 150,160, FIG. 4) in a conventional manner. After the individual frames have been captured, the user may press the playback button 60 (FIGS. 2-3) which places the camera in playback mode in which previously taken pictures may be reviewed by a user on the camera display 62.

After playback mode is entered, the user may then bring up the playback menu by pressing the “Menu/OK” button 66. The playback menu items are then displayed on the display 62 (and may, for example, be displayed as an overlay on the currently displayed image). The menu items may be navigated and selected using the scroll button 64 and Menu/Ok button 66 in a conventional manner. One of the playback menu items is a “Preview Panorama” option. When this option is selected by the user, the stitching/mosaicing operation previously discussed is performed on the individual image frames 140, 150, 160 to generate the panoramic image 180. The time required to generate the panoramic image 180 may, for example, be about ½ second per individual frame being stitched; although this, of course, depends upon hardware performance.

The panoramic image is then displayed on the display 62 for review by the user. Initially, the center portion of the panorama will be displayed on the display 62 and the panorama sequence will appear cropped by the right and left boundaries of the display (since the stitched panoramic preview image 180 (FIG. 5) will have a width “X” that is greater than the width “W” (FIG. 2) of the display 62). The user may scroll right and left along the panorama using the right and left arrows of the scroll button 64. Right and left arrow keys may appear as overlays on the displayed image to remind the user that scrolling is possible. The stitched panoramic preview image will fill the height of the display 62 when there is perfect vertical alignment between shots. Since, however, most alignments will be imperfect, the tops and bottoms of the shots may be cropped to make them appear even. It can be seen, for example, that, although the original image frames 140, 150, 160 each have a height equal to the display height “H” (see FIGS. 2 and 4), vertical misalignment between the image frames (as illustrated in FIG. 4) results in the panoramic image 180 having a height “Y” that is less than the height “H” (See FIGS. 2 and 5).

It is noted that the user interface methodology discussed above is exemplary of only one of any number of possible scenarios. As can be appreciated, different menu options and/or pathways could readily be employed to achieve the desired result.

While illustrative and presently preferred embodiments have been described in detail herein, it is to be understood that the inventive concepts may be otherwise variously embodied and employed and that the appended claims are intended to be construed to include such variations except insofar as limited by the prior art.

What is claimed is:

1. A method comprising:
providing a hand-held camera comprising an image sensor, a processor, a display and memory;
capturing a first image frame with said image sensor;
storing, in a first data file in said memory, a first high resolution data set corresponding to said first image frame at a relatively high resolution;
generating a first low resolution data set corresponding to said first image frame at a relatively low resolution, wherein said relatively low resolution is lower than said relatively high resolution;
storing said first low resolution data set in said first data file;
capturing a second image frame with said image sensor;
storing, in a second data file in said memory, a second high resolution data set corresponding to said second image frame at said relatively high resolution;
generating a second low resolution data set corresponding to said second image frame at said relatively low resolution;
storing said second low resolution data set in said second data file;
using said processor to generate an image mosaic by stitching together at least said first low resolution data set and said second low resolution data set; and
displaying said image mosaic on said display.

2. The method of claim 1 and further comprising:
deciding whether or not to recapture said first image frame and said second image frame by viewing said mosaic on said display.

3. The method of claim 1 and further comprising:
capturing a third image frame with said image sensor;
storing, in a third data file in said memory, a third high resolution data set corresponding to said third image frame at said relatively high resolution;
generating a third low resolution data set corresponding to said third image frame at said relatively low-resolution; and
wherein said using said processor to generate said image mosaic further comprises stitching together at least said second low resolution data set and said third low resolution data set.

4. The method of claim 1 and further comprising:
uploading said first high resolution data set and said second high resolution data set to a support computer;
using said support computer to generate a second image mosaic by stitching together at least said first high resolution data set and said second high resolution data set; and
wherein, said second image mosaic has a higher resolution relative to said image mosaic generated by said camera processor.

5. The method of claim 1 and further wherein:
said first low resolution data set corresponds to a screennail image.

6. The method of claim 1 and further wherein:
said image mosaic has a width greater than the width of said display.

7. The method of claim 6 and further comprising:
causing said image mosaic to scroll across said display in order to view the entire mosaic.

8. A method comprising:
providing a hand-held camera comprising an image sensor, a processor, a display and memory;
capturing a first image frame with said image sensor;
storing, in a first data file in said memory, a first data set corresponding to said first image frame;
capturing a second image frame with said image sensor;
storing, in a second data file in said memory, a second data set corresponding to said second image frame;
using said processor to generate an image mosaic by stitching together at least said first data set and said second data set; and
displaying said image mosaic on said display.

9. The method of claim 8 and further comprising:
deciding whether or not to recapture said first image frame and said second image frame by viewing said mosaic on said display.

10. The method of claim 8 and further comprising:
capturing a third image frame with said image sensor;
storing, in a third data file in said memory, a third data set corresponding to said third image frame; and
wherein said using said processor to generate said image mosaic further comprises stitching together at least said second data set and said third data set.

11. The method of claim 8 and further wherein:
said first data set corresponds to a screennail image.

12. The method of claim 8 and further wherein:
said image mosaic has a width greater than the width of said display.

13. The method of claim 12 and further comprising:
causing said image mosaic to scroll across said display in order to view the entire mosaic.

14. A handheld digital camera comprising:
means for generating a first data set corresponding to a first image and a second data set corresponding to a second image; and
means for combining said first data set with said second data set into a combined data set representative of a stitched panoramic image corresponding to said first image and said second image.

15. The handheld digital camera of claim 14 and further wherein:
said means for generating further comprises means for generating a third data set corresponding to a third image; and
said means for combining further comprises means for combining said first data set, said second data set and said third data set into a combined data set representative of a stitched panoramic image corresponding to said first image, said second image and said third image.

16. The handheld digital camera of claim 14 and further comprising:
means for displaying said stitched panoramic image.

17. The handheld digital camera of claim 14 and further wherein:
said first data set corresponds to a screennail image.

18. The handheld digital camera of claim 16 and further wherein:
said means for displaying comprises a display having a display width; and
said stitched panoramic image has a width greater than said display width.

19. The handheld digital camera of claim 18 and further comprising:
means for causing said image mosaic to scroll across said display in order to view the entire mosaic.
